(19) United States
(12) Patent Application Publication
(10) Pub. No.: US 2012/0144145 A1
(43) Pub. Date: Jun. 7, 2012

(54) APPARATUS AND METHOD FOR MEASURING LIFESPAN OF MEMORY DEVICE

(76) Inventor: Young-Kyun SHIN, Gyeonggi-do (KR)

(21) Appl. No.: 12/981,884

(22) Filed: Dec. 30, 2010

(30) Foreign Application Priority Data
Dec. 6, 2010 (KR) 10-2010-0123166

(51) Int. Cl. G06F 12/00; G06F 12/02

(52) U.S. Cl. 711/166; 711/154; 711/E12.001; 711/E12.002

(57) ABSTRACT

A method for measuring a lifespan of a memory device includes measuring an operation time of the memory device and generating lifespan information by comparing the measured operation time with a reference operation time.

### CROSS-REFERENCE TO RELATED APPLICATION

The present application claims priority of Korean Patent Application No. 10-2010-0123166, filed on Dec. 6, 2010, which is incorporated herein by reference in its entirety.

### BACKGROUND OF THE INVENTION

Exemplary embodiments of the present invention relate to an apparatus for measuring lifespan of a memory device and a method of operating the same.

Due to its high capacity and the high degree of the integration, a non-volatile memory device such as a flash memory is widely used as storage means of the portable information devices. Furthermore, a solid state device (SSD) using the non-volatile memory device, i.e., NAND flash memories, is replacing a hard disk drive for personal computers.

In order to rewrite a data of a semiconductor storage system using the flash memories, a selected area of the semiconductor storage system is to be erased before being programmed with the data. Accordingly, frequent usage of the semiconductor storage system accompanying with frequent erasing and programming operations accelerates the aging of memory cells of the semiconductor storage system. The aged memory cells are less likely to perform reliable operations. In order to protect the data stored in the semiconductor storage system, a lifespan of the semiconductor storage system is estimated and the data are timely backed-up before the semiconductor storage system breaks down. Generally, the semiconductor storage system reports information about the lifespan thereof to users through a self-monitoring, analysis, and reporting technology (SMART). The SMART counts the number of program/erase operations of the semiconductor storage system and determines whether the number of the program/erase operations reaches a certain value which may cause errors in an operation of the semiconductor storage system. However, the certain value causing the error of the semiconductor storage system can vary depending on various factors such as temperature and data use tendency. Therefore, the SMART may not provide an accurate lifespan of the semiconductor storage system.

### SUMMARY OF THE INVENTION

Exemplary embodiments of the present invention are directed to an apparatus and a method for providing lifespan information of a memory device by comparing an operation time of the memory device with a reference time.

In accordance with an exemplary embodiment of the present invention, a method for measuring a lifespan of a memory device, including measuring an operation time of the memory device; and generating a lifespan information by comparing the measured operation time with a reference operation time.

In accordance with another exemplary embodiment of the present invention, a controller for controlling a memory device, including a time measuring unit configured to measure an operation time of the memory device; and an analyzing unit configured to compare the operation time measured by the time measuring unit with a reference operation time and generate a lifespan information.

In accordance with further exemplary embodiment of the present invention, a storage system, including a memory device; and a controller configured to measure and store an initial operation time of the memory device and provide a lifespan information of the memory device by comparing an operation time of the memory device with the initial operation time.

### BRIEF DESCRIPTION OF THE DRAWINGS

FIGS. 1A and 1B are schematic diagrams respectively illustrating program and erase operations of a memory cell of a non-volatile memory device.

FIGS. 2A and 2B are waveform diagrams respectively illustrating an initial program time and a deteriorated program time of the non-volatile memory device.

FIG. 3 is a diagram schematically illustrating a lifespan measuring method of the non-volatile memory device in accordance with an embodiment of the present invention.

FIG. 4 is a diagram schematically illustrating a lifespan measuring method of the non-volatile memory device in accordance with another embodiment of the present invention.

FIG. 5 is a block diagram of a storage system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments.

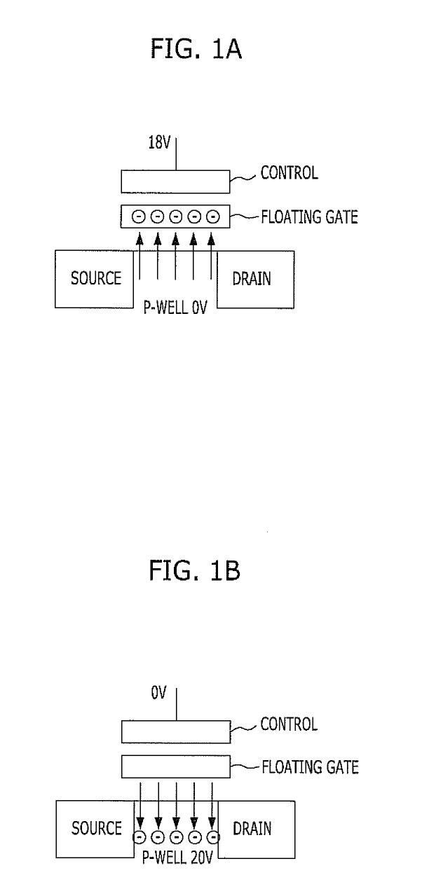

FIGS. 1A and 1B are schematic diagrams respectively illustrating program and erase operations of a memory cell of a non-volatile memory device.

As shown in FIG. 1A, a relatively high voltage, e.g., 18V, and a relatively low voltage, e.g., 0V, are respectively inputted to a control gate and a P-well of the memory cell for the program operation. Accordingly, electrons in the P-well are transferred to a floating gate due to a voltage difference between the control gate and the P-well of the memory cell during the program operation. As shown in FIG. 1B, a relatively low voltage, e.g., 0V, and a relatively high voltage, e.g., 20V, are respectively inputted to the control gate and the P-well of the memory cell for the erase operation. Accordingly, the electrons in the floating gate are transferred to the P-well due to the voltage difference between the control gate and the P-well of the memory cell during the erase operation.

That is, the program and erase operations of the memory cell of the non-volatile memory device are performed by electron transfer between the floating gate and the P-well thereof. As the program and erase operations are repeated, the electron is more easily transferred between the floating gate and the P-well and the program and erase operations are more rapidly performed.

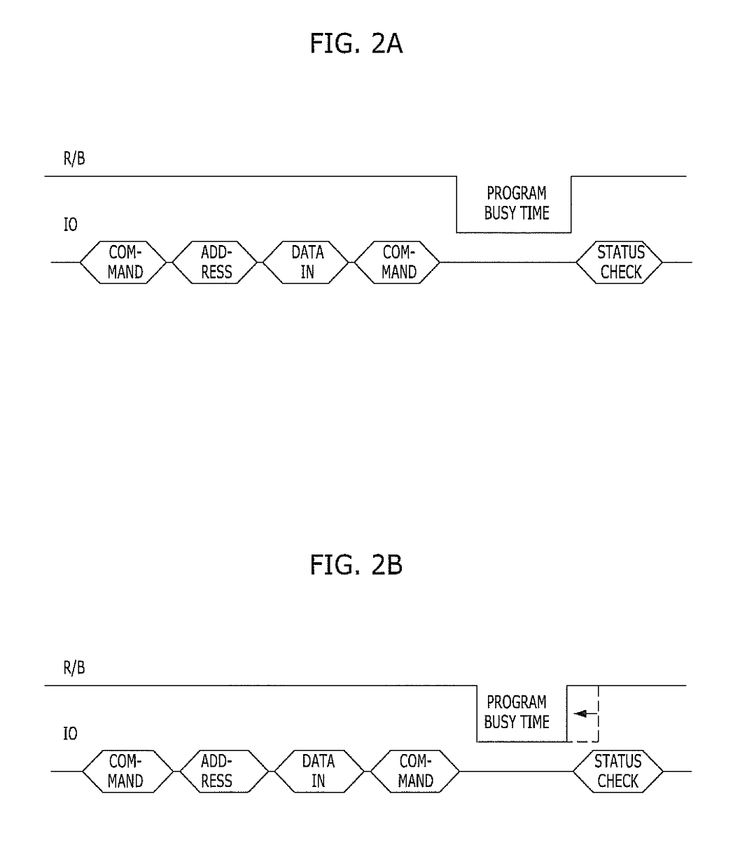

FIGS. 2A and 2B are waveform diagrams respectively illustrating an initial timing and a deteriorated timing of the program operation of the non-volatile memory device.

In FIGS. 2A and 2B, the reference “IO” denotes input timings of the command signal, address signal, and data signal of the non-volatile memory device; and the reference “R/B” denotes a ready/busy flag signal of the non-volatile memory device. The program operation of the non-volatile memory device is performed in a period where the ready/busy flag signal R/B has a logic low level. Comparing FIGS. 2A and 2B, the program time for the program operation is shortened as the non-volatile memory device is repeatedly used.

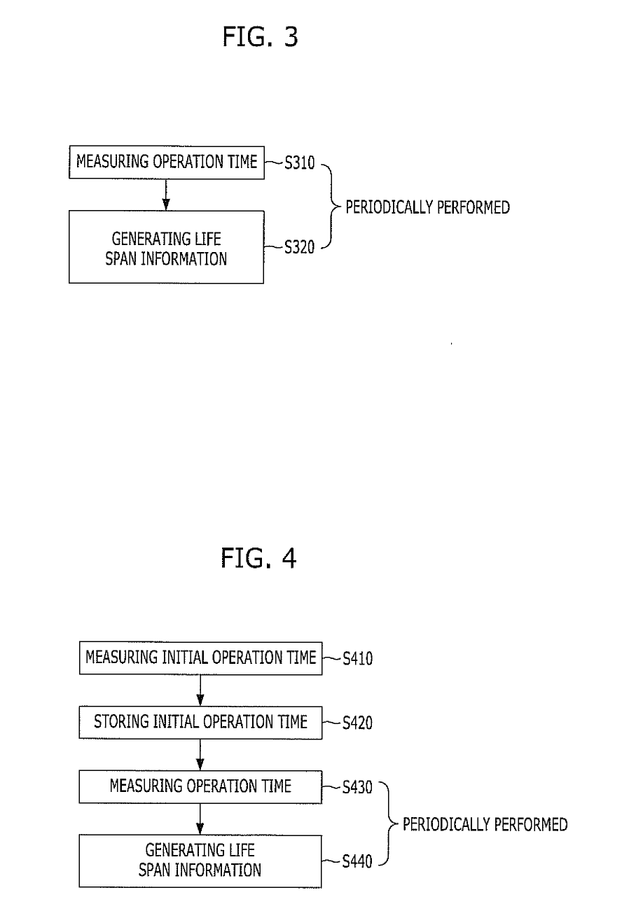

FIG. 3 is a diagram schematically illustrating a lifespan measuring method of the non-volatile memory device in accordance with an embodiment of the present invention.

First, an operation time of the non-volatile memory device is measured (S310). The operation time refers to a time taken to process the program operation or the erase operation of the non-volatile memory device. As mentioned above, the operation time is decreased as the non-volatile memory device repeatedly used and thus the program operation and the erase operation is repeatedly performed.

The operation time measured though the step S310 is compared with a reference time and lifespan information is generated (S320). As the measured operation time is closer to the reference time, the non-volatile memory device has less life left. Generally, the reference time is set to the operation time at the point when the lifespan of the non-volatile memory device almost ends. In this case, it may be determined that the lifespan of the non-volatile memory device is about to expire when the operation time measured though the step S310 is shorter than the reference time. On the other hand, it the reference time is set to the initial program time and the remaining lifespan of the non-volatile memory device is determined by detecting a decreased amount of the operation time compared with the reference time, i.e., the initial program time. For example, the lifespan of the non-volatile memory device having a 10% decrease in the operation time is longer than that of the non-volatile memory device having a 20% decrease in the operation time.

The steps of S310 and S320 may be periodically repeated. The steps of S310 and S320 may affect the performance/operation of the non-volatile memory device. Accordingly, the repetition period of the steps of S310 and S320 may be determined within certain ranges having no influence on the performance of the non-volatile memory device.

FIG. 4 is a diagram schematically illustrating a lifespan measuring method of the non-volatile memory device in accordance with another embodiment of the present invention.

First, an initial operation time of the non-volatile memory device is measured (S410). The initial operation time refers to a time taken to process the program operation or the erase operation of the non-volatile memory device which normally performs the operation thereof. Preferably, the initial operation time is measured when the non-volatile memory device is first used. After the step of S410 is completed, the initial operation time measured through the step of S410 is stored (S420).

An operation time of the non-volatile memory device is measured (S430). The operation time measured though the step S430 is compared with the initial operation time and lifespan information is generated (S440). As the operation time is shorter than the initial operation time, the non-volatile memory device has less life remaining. For example, the lifespan of the non-volatile memory device having a 10% decrease in the operation time is longer than that of the non-volatile memory device having a 20% decrease in the operation time.

The steps of S410 and S420 are performed once while the non-volatile memory device normally performs the operation thereof. On the other hand, the steps S430 and S440 are periodically performed to update the lifespan information of the non-volatile memory device.

The lifespan measuring methods of the non-volatile memory device depicted in FIGS. 3 and 4 may be performed for units or blocks of a non-volatile memory chip at a time. In such a case that the lifespan is measured for units of the non-volatile memory chip at a time, an average initial operation time of the memory blocks of the non-volatile memory chip is compared with an average measured operation time of the memory blocks of the non-volatile memory chip. In measuring the lifespan for units of the memory blocks in the non-volatile memory device at a time, the lifespan measuring method shown in FIGS. 3 and 4 is respectively performed for every memory block in the non-volatile memory device.

In the non-volatile memory device using a multi level cell (MLC) configuration, the lifespans of a most significant bit (MSB) page and a least significant bit (LSB) page are separately measured because the operation times of the MSB page and the LSB page are different each other.

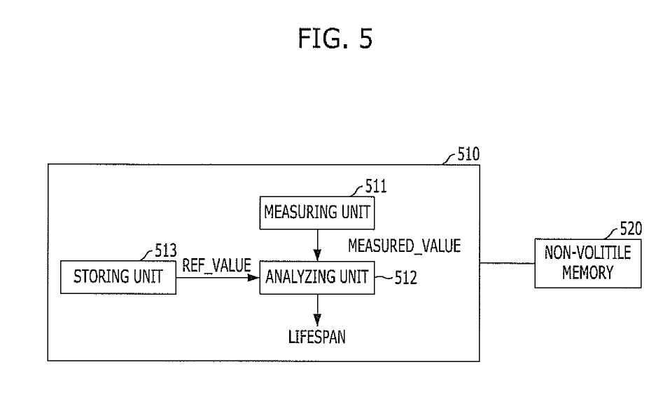

FIG. 5 is a block diagram of a storage system in accordance with an embodiment of the present invention.

The storage system includes a control unit 510 and a non-volatile memory 520. The control unit 510 measures the lifespan of the non-volatile memory 520.

The control unit 510 includes a measuring unit 511 configured to measure an operation time of the non-volatile memory 520, a storing unit 513 configured to store a reference time REF_VALUE, and an analyzing unit 512 configured to compare the reference time REF_VALUE with an output MEASURE_VALUE outputted from the measuring unit 511 and generate a lifespan information LIFESPAN.

The measuring unit 511 measures an operation time of the non-volatile memory 520 by using a ready/busy flag signal (R/B) outputted from the non-volatile memory 520. The storing unit 513 stores the reference time REF_VALUE. As mentioned above, the reference time REF_VALUE may be set to the operation time at the point when the lifespan of the non-volatile memory 520 almost ends or to the initial program time measured while the non-volatile memory 520 normally operates. In such a case that the reference time REF_VALUE is set to the initial program time, the output MEASURE_VALUE outputted from the measuring unit 511 is stored in the storing unit 513 when the non-volatile memory 520 normally operates. Once after the reference time REF_VALUE is set, it is preferable not to change the value of the reference time REF_VALUE. The analyzing unit 512 compares the reference time REF_VALUE with the output MEASURE_VALUE of the measuring unit 511 and generates the lifespan information LIFESPAN.

In the embodiment shown in FIG. 5, single non-volatile memory 520 is connected to the control unit 510. However, a plurality of the non-volatile memories 520 may also be connected to the control unit 510 and the lifespans of the non-volatile memories 520 may be measured.

Various kinds of memory systems, such as a solid state device (SSD) drive, a universal serial bus (USB) memory, and a memory card, may have the structure of the storage system shown in FIG. 5.

According to an embodiment of the present invention, the lifespan of the non-volatile memory device is measured by comparing an operation time of the non-volatile memory device with a reference time. Therefore, the embodiment of the present invention may provide an accurate lifespan of the storage system in spite of unpredictable factors such as temperature and data use tendency.

While the present invention has been described with respect to the specific embodiments, it will be apparent to those skilled in the art that various changes and modifications may be made without departing from the spirit and scope of the invention as defined in the following claims.

What is claimed is:

1. A method for measuring a lifespan of a memory device, comprising:
measuring an operation time of the memory device; and
generating a lifespan information by comparing the measured operation time with a reference operation time.

2. The method of claim 1, wherein the reference operation time is an expected operation time of the memory device at the end of the lifespan of the memory device.

3. The method of claim 1, wherein the operation time is a time for performing a program operation of the memory device.

4. The method of claim 1, wherein the operation time is a time for performing an erase operation of the memory device.

5. The method of claim 1, wherein, as the measured operation time gets shorter, the lifespan information is changed to indicate that less lifespan remains for the memory device.

6. The method of claim 1, wherein the measuring of the operation time and the generating of the lifespan information are periodically performed while the memory device performs program and erase operations.

7. The method of claim 1, wherein the operation time of the memory device is measured by using a ready/busy signal of the memory device.

8. The method of claim 1, before the measuring of the operation time, further comprising:
measuring an initial operation time of the memory device; and
storing the initial operation time as the reference operation time.

9. A controller for controlling a memory device, comprising:
a time measuring unit configured to measure an operation time of the memory device; and
an analyzing unit configured to compare the operation time measured by the time measuring unit with a reference operation time and generate a lifespan information.

10. The controller of claim 9, wherein the time measuring unit is configured to measure the operation time by using a ready/busy signal outputted from the memory device.

11. The controller of claim 9, further comprising a storing unit configured to store an expected operation time of the memory device at the end of the lifespan of the memory device.

12. The controller of claim 9, wherein the operation time is a time for performing a program operation of the memory device.

13. The controller of claim 9, wherein the operation time includes a time for performing an erase operation of the memory device.

14. The controller of claim 9, wherein the time measuring unit and the analyzing unit are configured to periodically perform operations thereof.

15. A storage system, comprising:
a memory device; and
a controller configured to measure and store an initial operation time of the memory device and provide a lifespan information of the memory device by comparing an operation time of the memory device with the initial operation time.

16. The storage system of claim 15, wherein the initial operation time and the operation time are each a time for performing a program operation of the memory device.

17. The storage system of claim 15, wherein the initial operation time and the operation time are each a time for performing an erase operation of the memory device.

18. The storage system of claim 15, wherein the controller includes:
a time measuring unit configured to measure the operation time of the memory device; and
an analyzing unit configured to compare the operation time measured by the time measuring unit with the initial operation time and generate the lifespan information.
